(19) United States
(12) Patent Application Publication
(10) Pub. No.: US 2025/0085841 A1
(43) Pub. Date: Mar. 13, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventors: RYOYA KAWAI, Kanagawa (JP); YU KAWAI, Kanagawa (JP)

(21) Appl. No.: 18/825,752

(22) Filed: Sep. 5, 2024

(30) Foreign Application Priority Data
Sep. 8, 2023 (JP) 2023-146301

(51) Int. Cl. G06F 3/0486; G06F 3/04817; G06F 9/451

(52) U.S. Cl. CPC G06F 3/0486; G06F 3/04817; G06F 9/451

(57) ABSTRACT

A control method includes the following: executing, based on receiving an operation of dragging the file icon included in the screen displayed by the first application program and an operation of dropping the dragged file icon on an application icon associated with a third application program and based on a fact that the third application program does not support the first method, second processing for sharing the file associated with the dropped file icon with the third application program by a second method.

### BACKGROUND

### Field of the Disclosure

The present disclosure relates to an information processing apparatus, a control method, and a storage medium.

### Description of the Related Art

Japanese Patent Laid-Open No. 2020-154525 describes that an information processing apparatus receives an operation of dragging and dropping a file icon.

As a form in which an information processing apparatus receives an operation of dragging and dropping a file icon becomes more widespread, it is desired to improve the convenience of this form.

### SUMMARY

Embodiments of the present disclosure provide a technique for improving the convenience of a form in which an information processing apparatus receives an operation of dragging and dropping a file icon.

According to some embodiments of the present disclosure, a method for controlling an information processing apparatus having a predetermined program includes the following: executing, based on receiving a dragging operation of dragging a file icon included in a screen displayed by a first application program and a dropping operation of dropping the dragged file icon on an application icon associated with a second application program and based on a fact that the second application program supports a first method, first processing for sharing a file associated with the dropped file icon with the second application program by the first method; and executing, based on receiving a dragging operation of dragging the file icon included in the screen displayed by the first application program and a dropping operation of dropping the dragged file icon on an application icon associated with a third application program and based on a fact that the third application program does not support the first method, second processing for sharing the file associated with the dropped file icon with the third application program by a second method.

Further features of various embodiments of the present disclosure will become apparent from the following description of exemplary embodiments with reference to the attached drawings.

### BRIEF DESCRIPTION OF THE DRAWINGS

FIG. 1 is a diagram illustrating an example of a communication system.

FIG. 2 is a diagram illustrating an example of configurations of a terminal apparatus and a communication apparatus.

FIG. 3 is a flowchart illustrating a process that is executed by the terminal apparatus using an OS.

FIG. 4 is a flowchart illustrating a process that is executed by the terminal apparatus using the OS.

FIG. 5 is a flowchart illustrating a process that is executed by the terminal apparatus using a first printing application.

FIG. 6 is a flowchart illustrating a process that is executed by the terminal apparatus using a second printing application.

FIGS. 7A to 7D are diagrams illustrating examples of screens displayed by the terminal apparatus.

FIGS. 8A to 8C are diagrams illustrating examples of screens displayed by the terminal apparatus.

### DESCRIPTION OF THE EMBODIMENTS

### First Embodiment

An information processing apparatus and a communication apparatus that are included in a communication system according to the present embodiment will be described. In the present embodiment, as the information processing apparatus, a smartphone is exemplified. However, the information processing apparatus is not limited thereto. As the information processing apparatus, various apparatuses such as a terminal apparatus, a laptop PC, a tablet terminal, a personal digital assistant (PDA), and a digital camera can be used. In addition, in the present embodiment, as the communication apparatus, a printer is exemplified. However, the communication apparatus is not limited thereto. Various apparatuses can be used as the communication apparatus as long as the apparatuses can wirelessly communicate with the information processing apparatus. For example, in a case where the communication apparatus is a printer, an ink jet printer, a full-color laser beam printer, a monochrome printer, and the like can be used. Further, in addition to the printers, a copy machine, a facsimile machine, a terminal apparatus, a smartphone, a laptop PC, a tablet terminal, a PDA, a digital camera, a music playing device, a television, a smart speaker, and the like can be used as the communication apparatus. Further, a multi-function peripheral having a plurality of functions including a copy function, a facsimile function, and a print function can be used as the communication apparatus.

First, a system configuration for implementing the present embodiment will be described.

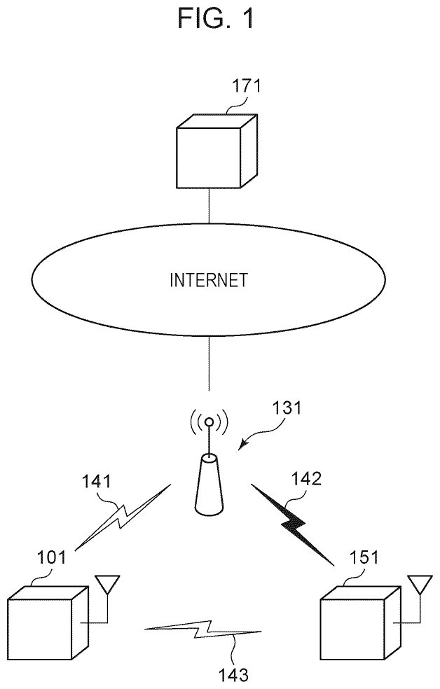

FIG. 1 is a diagram illustrating an example of the configuration of the communication system according to the present embodiment. The communication system includes a communication apparatus 151, a terminal apparatus 101, an access point (AP) 131, and an external server 171.

The terminal apparatus 101 is the information processing apparatus according to the present embodiment. The communication apparatus 151 is the communication apparatus according to the present embodiment. The AP 131 is an external apparatus present outside the terminal apparatus 101 and the communication apparatus 151. The external server 171 can provide a service through the Internet to the apparatuses connected to the AP 131.

The AP 131, the communication apparatus 151, and the terminal apparatus 101 are included in a local area network (LAN) formed by the AP 131. The AP 131 and the external server 171 are included in a wide area network (WAN).

In the present embodiment, in a case where an infrastructure connection described later is established, the terminal apparatus 101 can communicate with the communication apparatus 151 via the AP 131. In a case where a direct connection described later is established, the terminal apparatus 101 can directly communicate with the communication apparatus 151 without the AP 131. In the following description, a connection to an AP corresponds to a connection to a network formed by the AP. The AP may concurrently form a plurality of networks. In this case, the connection to the AP may be a connection to any one of the networks formed by the AP.

In the present embodiment, it is assumed that a connection 141 between the terminal apparatus 101 and the AP 131 and a connection 142 between the communication apparatus 151 and the AP 131 are connections by a communication method based on the IEEE802.11 series of standards. Specifically, the communication method based on the IEEE802.11 series of standards is Wireless Fidelity (Wi-Fi)®. In the present embodiment, it is assumed that a connection 143 between the terminal apparatus 101 and the communication apparatus 151 is a connection by Wi-Fi or a connection by Bluetooth® Low Energy (BLE).

The communication method used for each of the connections is not limited thereto and may be Bluetooth Classic, Wi-Fi Aware, near-field communication (NFC), or the like. The AP 131 and the external server 171 can communicate with each other via the Internet. In a state in which the AP 131 is connected to the Internet, the Internet is available for use by the apparatuses (terminal apparatus 101 and communication apparatus 151) connected to the AP 131. Each of the connection 141 between the terminal apparatus 101 and the AP 131 and the connection 142 between the communication apparatus 151 and the AP 131 may be a connection by a wired LAN.

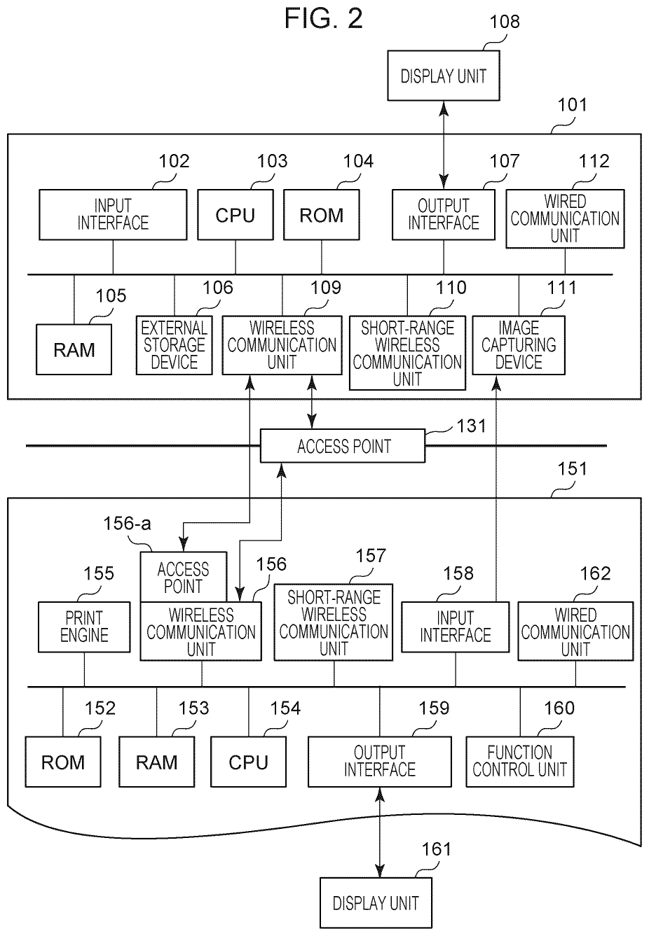

Next, a configuration of the information processing apparatus according to the present embodiment and a configuration of the communication apparatus that can communicate with the information processing apparatus according to the present embodiment will be described with reference to a block diagram of FIG. 2. In the present embodiment, the following configurations are described as an example. However, the present embodiment does not particularly limit functions to functions described with reference to FIG. 2 as long as an apparatus that can communicate with the communication apparatus can be used as the information processing apparatus according to the present embodiment.

The terminal apparatus 101 includes an input interface 102, a CPU 103, a ROM 104, a RAM 105, an external storage 106, an output interface 107, a display unit 108, a wireless communication unit 109, a short-range wireless communication unit 110, an image capturing device 111, and a wired communication unit 112. The CPU 103, the ROM 104, the RAM 105, and the like form a computer of the terminal apparatus 101. The terminal apparatus 101 is assumed to be a device such as a smartphone, but is not limited to the smartphone.

The input interface 102 receives data input and an operation instruction from a user and includes a physical keyboard, buttons, a touch panel, and the like. The output interface 107 described later and the input interface 102 may be included in the same configuration, and output of a screen and reception of an operation from the user may be performed in the same configuration.

The CPU 103 is a system control unit and controls the entire terminal apparatus 101.

The ROM 104 stores fixed data such as a control program to be executed by the CPU 103, a data table, and an operating system (hereinafter referred to as an OS) program. In the present embodiment, control programs stored in the ROM 104 perform software execution control such as scheduling, task switching, and interruption processing under management by the embedded OS stored in the ROM 104. In the present embodiment, it is assumed that the OS included in the terminal apparatus 101 is iOS® 17. However, the OS is not limited thereto and may be an OS that supports a function of sharing a file by dragging and dropping described later. Specifically, for example, the OS may be iPadOS® 17. The OS may be iOS of a version later than iOS 17. In the present embodiment, the ROM 104 stores a printing application program (hereinafter referred to as a printing application). The printing application is installed in the terminal apparatus 101 from an external by, for example, a store application program. The printing application is an application provided by a vendor of the communication apparatus 151. The printing application may have other functions other than a function of transmitting a print job for causing the communication apparatus 151 to perform printing. Specifically, for example, the other functions are a function of performing a network setup for the communication apparatus 151, and a function of transmitting a scan job for causing the communication apparatus 151 to perform scanning. In the present embodiment, processing described as processing executed by the OS is precisely processing executed by the CPU 103 in accordance with a program within the OS. Similarly, processing described as processing executed by the printing application is precisely processing executed by the CPU 103 in accordance with the printing application.

The RAM 105 includes a static random access memory (SRAM) that requires a backup power source. Since data is held in a primary battery (not illustrated) for data backup, important data such as a program control variable can be stored in the RAM 105 without being volatile. In addition, a memory area for storing setting information of the terminal apparatus 101, management data of the terminal apparatus 101, and the like is provided in the RAM 105. The RAM 105 is also used as a main memory and a work memory of the CPU 103.

The external storage 106 includes various programs including a print information generation program for generating print information interpretable by the communication apparatus 151 and an information transmission and reception control program for transmitting and receiving information to and from the communication apparatus 151 connected to the terminal apparatus 101 via the wireless communication unit 109. The external storage 106 stores various types of information that is used by these programs. The external storage 106 also stores image data acquired from another information processing apparatus and the Internet.

The output interface 107 controls displaying of data by the display unit 108 and notification of the state of the terminal apparatus 101 by the display unit 108.

The display unit 108 includes a light emitting diode (LED) and a liquid crystal display (LCD). The display unit 108 displays data and notifies the state of the terminal apparatus 101. A software keyboard that includes keys including a numeral input key, a mode setting key, a determination key, a cancel key, and a power supply key may be provided on the display unit 108, and the terminal apparatus 101 may receive input from the user via the display unit 108. In the present embodiment, it is assumed that the display unit 108 is a touch panel and can receive an operation by a user using an operator such as a finger or a pen.

The wireless communication unit 109 is wirelessly connected to apparatuses such as the communication apparatus 151 and the AP 131 and is configured to perform data communication with the apparatuses such as the communication apparatus 151 and the AP 131. For example, the wireless communication unit 109 may wirelessly directly communicate with the communication apparatus 151 or may communicate with the communication apparatus 151 via the AP 131 present outside the terminal apparatus 101 and the communication apparatus 151. In the present embodiment, it is assumed that, as a wireless communication method of the wireless communication unit 109, Wi-Fi that is a communication method based on the IEEE802.11 series of standards is used, but Bluetooth Classic or the like may be used. In addition, in the present embodiment, it is assumed that a wireless LAN is a network by Wi-Fi. An example of the AP 131 is a device such as a wireless LAN router. In the present embodiment, a method in which the terminal apparatus 101 and the communication apparatus 151 are directly connected to each other without an external AP is referred to as a direct connection method. In the present embodiment, a method in which the terminal apparatus 101 and the communication apparatus 151 are connected to each other via an external AP is referred to as an infrastructure connection method.

The short-range wireless communication unit 110 performs data communication with an apparatus such as the communication apparatus 151 using a short-range wireless communication method and performs the communication using the communication method different from that of the wireless communication unit 109. The short-range wireless communication unit 110 can be connected to a short-range wireless communication unit 157 within the communication apparatus 151. Examples of the communication method of the short-range wireless communication unit 110 are BLE, Bluetooth Classic, Wi-Fi Aware, and NFC.

The image capturing device 111 converts an image captured by an image capturing element into digital data.

The digital data is temporarily stored in the RAM 105. Thereafter, a program executed by the CPU 103 converts the digital data into data in a predetermined image format and stores the converted data as image data to the external storage 106.

The wired communication unit 112 is connected to apparatuses such as the communication apparatus 151 and the AP 131 via a cable or the like and performs data communication with the apparatuses such as the communication apparatus 151 and the AP 131 via the cable or the like. For example, the wired communication unit 112 performs the communication by a wired LAN. In the present embodiment, it is assumed that, in the wired LAN, the communication is performed in accordance with an Ethernet standard. The wired communication unit 112 is not limited thereto. For example, the wired communication unit 112 may perform communication via a Universal Serial Bus (USB) cable.

The communication apparatus 151 includes a ROM 152, a RAM 153, a CPU 154, a print engine 155, a wireless communication unit 156, the short-range wireless communication unit 157, an input interface 158, an output interface 159, a function control unit 160, a display unit 161, a wired communication unit 162, and the like.

The ROM 152, the RAM 153, the CPU 154, and the like form a computer of the communication apparatus 151.

The wireless communication unit 156 is wirelessly connected to apparatuses such as the terminal apparatus 101 and the AP 131 and performs data communication with the apparatuses such as the terminal apparatus 101 and the AP 131. In the present embodiment, it is assumed that Wi-Fi is used as a wireless communication method of the wireless communication unit 156. However, Bluetooth Classic or the like may be used as the wireless communication method of the wireless communication unit 156. The wireless communication unit 156 includes, as an AP within the communication apparatus 151, an AP 156-a for connection to an apparatus such as the terminal apparatus 101. The AP 156-a can be connected to the wireless communication unit 109 of the terminal apparatus 101. The wireless communication unit 156 may directly communicate with the terminal apparatus 101 via the AP 156-a or may communicate with the terminal apparatus 101 via the AP 131. The AP 156-a may be hardware that functions as the AP.

Alternatively, the wireless communication unit 156 may operate as the AP 156-a by software for functioning as the AP. In addition, the AP within the communication apparatus 151 may include a plurality of APs having different service set identifiers (SSIDs) and different passwords.

The RAM 153 includes a DRAM or the like that requires a backup power source. Data is held in the RAM 153 by supply of electric power (not illustrated) for data backup. Therefore, important data such as a program control variable can be stored in the RAM 153 without being volatile. In addition, the RAM 153 is used as a main memory and a work memory of the CPU 154 and stores various types of information as a receiving buffer for temporarily storing print information received from the terminal apparatus 101 or the like.

The ROM 152 stores fixed data such as a control program to be executed by the CPU 154, a data table, and an OS program. In the present embodiment, control programs stored in the ROM 152 perform software execution control such as scheduling, task switching, and interruption processing under management by the embedded OS stored in the ROM 152. In addition, the ROM 152 includes a memory area for storing data that is setting information of the communication apparatus 151, management data of the communication apparatus 151, and the like and is required to be held even in a case that electric power is not supplied.

The CPU 154 is a system control unit and controls the entire communication apparatus 151.

The print engine 155 uses a recording material such as ink to form an image on a recording medium such as paper and outputs a print result based on information stored in the RAM 153 and a print job received from the terminal apparatus 101 or the like. In this case, the print job transmitted from the terminal apparatus 101 or the like has a large amount of transmission data, high-speed communication is required, and thus the print job is received via the wireless communication unit 156 that can perform communication at higher speed than the short-range wireless communication unit 157.

The short-range wireless communication unit 157 communicates with an apparatus such as the terminal apparatus 101 using a short-range wireless communication method. Examples of the communication method of the short-range wireless communication unit 157 are BLE, Bluetooth Classic, and Wi-Fi Aware.

The input interface 158 receives data input and an operation instruction from the user and includes a physical keyboard, buttons, a touch panel, and the like. The output interface 159 described later and the input interface 158 may be included in the same configuration, and output of a screen and reception of an operation from the user may be performed in the same configuration. The output interface 159 controls displaying of data by the display unit 161 and notification of the state of the communication apparatus 151 by the display unit 161.

The function control unit 160 manages a function operation of determining whether functions included in the communication apparatus 151 are to be concurrently operated.

The display unit 161 includes a light emitting diode (LED) and a liquid crystal display (LCD). The display unit 161 displays data and notifies the state of the communication apparatus 151. A software keyboard that includes keys including a numeral input key, a mode setting key, a determination key, a cancel key, and a power supply key may be provided on the display unit 161, and the communication apparatus 151 may receive input from the user via the display unit 161.

The wired communication unit 162 is connected to apparatuses such as the terminal apparatus 101 and the AP 131 via a cable or the like and perform data communication with the apparatuses such as the terminal apparatus 101 and the AP 131 via the cable or the like. For example, the wired communication unit 162 performs the communication by a wired LAN. The wired communication unit 162 is not limited thereto and may perform the communication via, for example, a USB cable.

### Regarding Function of Sharing File by Dragging and Dropping

In the present embodiment, the terminal apparatus 101 can display a home screen for the OS. On the home screen for the OS, an icon (hereinafter referred to as an application icon) associated with an application installed in the terminal apparatus 101 is displayed. When application icon is tapped by a user, the application associated with the tapped application icon is activated. In the present embodiment, it is assumed that the terminal apparatus 101 has a file management application installed therein. The file management application can manage various files held in the terminal apparatus 101 and various files accessible by the terminal apparatus 101. The file management application can display a list screen indicating a list of these files. On the list screen, for example, the files are displayed as icons (file icons) associated with the files. In the present embodiment, it is assumed that the file management application displays, on the list screen, file icons associated with a PDF format file, a JPEG format file, a HEIF format file, and a PNG format file. On the list screen, for example, file icons associated with other format files such as a BMP format file, a TIFF format file, a GIF format file, an MP3 format file, and an MP4 format file may be displayed. In the present embodiment, after the user selects a file icon displayed by the file management application by tapping the file icon using the operator, the user can drag the file icon without separating the operator from the display unit 108. In this case, a plurality of file icons may be selected, and the plurality of file icons may be dragged in a state in which the plurality of file icons are selected. In addition, when the user separately performs an operation for displaying the home screen for the OS in a state in which a selected icon is dragged, the screen displayed by the display unit 108 is switched from the list screen to the home screen for the OS. The operation for displaying the home screen for the OS is, for example, an operation of pressing a home button that is a physical button included in the terminal apparatus 101. For example, in a case where the terminal apparatus 101 is an apparatus (tablet terminal or the like) having a relatively large display unit, and a screen displayed by the file management application and the home screen for the OS are concurrently displayed, it is not necessary to separately perform the operation for displaying the home screen for the OS in a state in which the file icon is dragged. In the present embodiment, when the user moves the operator, with which the file icon is being dragged, to an application icon displayed on the home screen for the OS, and drops the file icon by separating the operator on the application icon from the display unit 108, a file associated with the selected file icon can be input to an application associated with the application icon. That is, in the present embodiment, in a case that the user drags a file icon displayed by the file management application to an application icon and drops the file icon on the application icon, a file associated with the file icon can be input to an application associated with the application icon.

Specifically, when the file icon is dropped on the application icon, the OS of the terminal apparatus 101 starts to store the file associated with the dropped file icon to a predetermined storage region accessible by the application associated with the application icon on which the file icon has been dropped. Thereafter, the OS of the terminal apparatus 101 instructs the application associated with the application icon on which the file has been dropped to execute a predetermined method that is scene(_:openURLContexts:) defined in the UISceneDelegate protocol. In the present embodiment, processing of instructing, by the OS, the application to execute the method corresponds to, in other words, processing of calling, by the OS, the method implemented in the application. In this case, the OS of the terminal apparatus 101 executes the instruction using, as an argument, a file path indicating a region in which the file associated with the dropped file icon is stored, and notifies the application of the file path. When the application executes the predetermined method based on the instruction described above, the application is activated and accesses the region indicated by the file path acquired from the OS to acquire the file. Then, the application executes processing for the acquired file. In this manner, the file from the file management application is enabled to be shared with the other application.

However, in a case where the file icon is dropped on the application icon and the application associated with the application icon cannot execute processing for the function of sharing a file by dragging and dropping, the application cannot appropriately process the file associated with the file icon dragged and dropped. Specifically, for example, even in a case where the application does not include a program for executing the predetermined method, and the application is instructed to execute the predetermined method from the OS of the terminal apparatus 101, the application cannot execute the predetermined method and cannot appropriately process the file. In addition, in a case that the OS of the terminal apparatus 101 instructs an application not including a program for executing the predetermined method to execute the predetermined method, the application may be crashed immediately after being activated.

In the present embodiment, a form in which a process that is performed by the OS so that an application can appropriately process data dragged and dropped is controlled will be described.

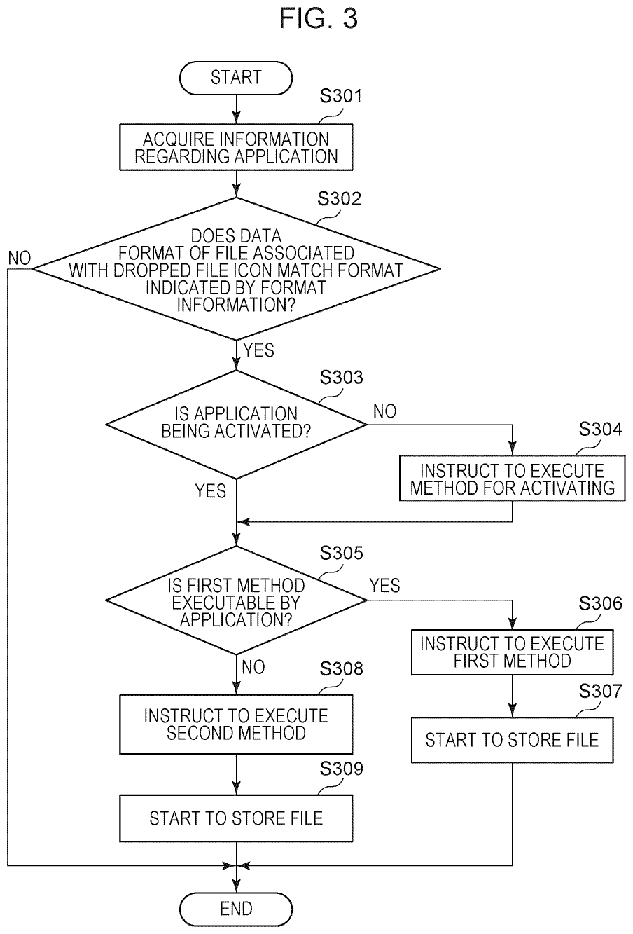

FIG. 3 is a flowchart illustrating the process that is executed by the terminal apparatus 101 using the OS. The flowchart in FIG. 3 is implemented by the CPU 103 reading the program (specifically, the OS) stored in the ROM 104 into the RAM 105 and executing the read program. It is assumed that the flowchart in FIG. 3 is started based on a file icon being dragged and dropped on an application icon associated with the printing application.

In S301, the CPU 103 acquires information regarding the printing application from the printing application. In S301, the CPU 103 may acquire the information regarding the printing application from information managed by the OS. Specifically, for example, the information regarding the printing application includes format information indicating a file format supported by an application associated with an application icon on which a file icon has been dropped in a function of accepting sharing of a file from another application. The format information may indicate an extension corresponding to the file format supported by the application associated with the application icon on which the file has been dropped. In the present embodiment, it is assumed that the printing application supports the PDF format, the JPEG format, the HEIF format, and the PNG format in the function of accepting sharing of a file from another application. In other words, it is assumed that the format information of the printing application indicates the PDF format, the JPEG format, the HEIF format, and the PNG format. The printing application may be able to support a file in a format other than the above-described formats in a function of processing a file selected on a selection screen displayed on the printing application. Specifically, for example, on the selection screen displayed on the printing application, files in other formats such as the BMP format, the TIFF format, and GIF format may be selectable. In a case that a file in another format is selected, the printing application may be able to generate print data for printing the file in the other format and transmit the print data to the communication apparatus 151. In the present embodiment, specifically, for example, the information regarding the printing application includes method information indicating whether a first method that is a predetermined method is executable by the printing application. The method information is, in other words, information indicating whether the printing application includes a program for executing the first method.

In S302, the CPU 103 determines whether a data format of the file associated with the file icon dropped on the application icon associated with the printing application matches the format indicated by the format information acquired in S301. In a case that the data format does not match the format indicated by the format information, the CPU 103 ends the process without instructing the printing application to execute a method. That is, in a case that the CPU 103 determines that the data format does not match the format indicated by the format information, the process ends without the printing application being activated and without the file associated with the file icon dropped on the application icon being acquired by the printing application. On the other hand, in a case that the CPU 103 determines that the data format matches the format indicated by the format information, the process proceeds to S303. The OS acquires, from the file management application, information indicating which format the file associated with the file icon dropped on the application icon associated with the printing application is in. It is assumed that, in a case that a plurality of file icons are simultaneously dropped on the application icon associated with the printing application, and at least one of a plurality of files associated with the plurality of file icons dropped matches the format indicated by the format information acquired in S301, the CPU 103 determines YES in S302. That is, it is assumed that, in a case that a plurality of file icons are simultaneously dropped on the application icon associated with the printing application, and all a plurality of files associated with the plurality of file icons dropped do not match the format indicated by the format information acquired in S301, the CPU 103 determines NO in S302. In S303, the CPU 103 determines whether the printing application is being activated. The process of the flowchart in FIG. 3 is executed in a state in which the home screen for the OS is displayed. Therefore, a state in which the printing application is being activated at the time of making the determination in S303 corresponds to a state in which the printing application is being executed in a background process. In a case that the CPU 103 determines that the printing application is not being activated, the process proceeds to S304. In a case that the CPU 103 determines that the printing application is being activated, the process proceeds to S305.

In S304, the CPU 103 instructs the printing application to execute a method for activating the printing application. Therefore, the printing application is activated and the screen displayed on the display unit 108 is switched from the home screen for the OS to a screen displayed by the printing application.

In S305, the CPU 103 determines, based on the method information acquired in S301, whether the first method is executable by the printing application. Specifically, the CPU 103 determines whether the printing application supports the UISceneDelegate protocol. In a case that the CPU 103 determines that the first method is executable by the printing application, the process proceeds to S306. In a case that the CPU 103 determines that the first method is not executable by the printing application, the process proceeds to S308.

In S306, the CPU 103 instructs the printing application to execute the first method. Specifically, the CPU 103 uses the OS to execute an application programming interface (API) for causing the printing application to execute the first method. As the API is executed, the printing application executes the first method. As described above, the first method is the predetermined method that is scene(_:openURLContexts:) defined in theUISceneDelegate protocol. In a case that the CPU 103 determines NO in S303, the CPU 103 may instruct the printing application to execute a method that is scene(_:willConnectTo:options:) defined in the UISceneDelegate protocol. In a case that the CPU 103 determines YES in S303, the CPU 103 may instruct the printing application to execute a method that is scene(_:openURLContexts:) defined in the UISceneDelegate protocol.

In this case, the CPU 103 executes the instruction using, as arguments, a file path indicating a region in which the dropped file is stored, identification information of the application (file management application in this case) that displayed the dropped file, and the like, and causes the printing application to acquire the information used as the arguments. In processing of instructing the printing application to execute the first method, the CPU 103 can use a plurality of file paths as arguments. In other words, in the processing of instructing the printing application to execute the first method, in a case that a plurality of file icons are dropped on the application icon associated with the printing application, the CPU 103 can cause the printing application to acquire a plurality of file paths associated with the plurality of files associated with the plurality of file icons dropped. In a case that a plurality of file icons are dropped on the application icon associated with the printing application, the printing application can acquire a plurality of files associated with the plurality of file icons dropped.

However, the present embodiment is not limited thereto. In the process (that is, the process of the flowchart in FIG. 3) executed based on a predetermined button being operated, a plurality of file paths are not available as arguments in the processing of instructing the printing application to execute the first method in a similar manner to processing of instructing to execute a second method.

In S307, the CPU 103 starts to store the file associated with the file icon dropped on the application icon associated with the printing application to a predetermined storage region accessible by the printing application. In a case where the file associated with the file icon dropped is present on the Internet outside the terminal apparatus 101, the CPU 103 starts to receive the file from the Internet and starts to store the file to the predetermined storage region. The file on the Internet outside the terminal apparatus 101 is, in other words, a file that is held in a server outside the terminal apparatus 101 and can be acquired by the terminal apparatus 101 via the Internet. The CPU 103 may store, to the predetermined storage region, only a file in a data format supported by the printing application among the files associated with the file icons dropped, and may not store a file in a data format not supported by the printing application. In addition, in a case that a plurality of file icons are dropped on the application icon associated with the printing application, the CPU 103 starts to store, to the predetermines storage region, a plurality of files associated with the plurality of file icons. The order in which the processing in S307 and the processing in S306 are executed is not limited. That is, for example, after the storing of the file associated with the file icon dropped on the application icon associated with the printing application is started, the processing of instructing the printing application to execute the first method may be executed and the file path may be acquired by the printing application. In addition, in a case where a file already stored in the predetermined storage region is present among the files associated with the file icons dropped on the application icon associated with the printing application, processing of storing the file to the predetermined storage region may be omitted. The file already stored in the predetermined region is, for example, a file associated with a file icon that was dropped on the application icon associated with the printing application in the past. After S307, the process of the flowchart in FIG. 3 ends.

In S308, the CPU 103 instructs the printing application to execute the second method. Specifically, the CPU 103 uses the OS to execute an API for causing the printing application to execute the second method. As the API is executed, the printing application executes the second method. The second method is a method that is application(_:open:options:) defined in the UIApplicationDelegate protocol. In this case, the CPU 103 executes the instruction using, as arguments, a file path indicating a region in which the dropped file is stored, identification information of the application (file management application in this case) that displayed the dropped file, and the like, and causes the printing application to acquire the information used as the arguments. In processing of instructing the printing application to execute the second method, the CPU 103 cannot use a plurality of file paths as arguments. In other words, in the processing of instructing the printing application to execute the second method, even in a case that a plurality of file icons are dropped on the application icon associated with the printing application, the CPU 103 cannot cause the printing application to acquire a single file path associated with a single file associated with a single file icon among the plurality of file icons dropped. In a case that a plurality of file icons are dropped on the application icon associated with the printing application, the printing application can acquire only a single file associated with a single file icon among the plurality of file icons dropped.

In S309, the CPU 103 starts to store, to a predetermined storage region accessible by the printing application, the file associated with the file icon dropped on the application icon associated with the printing application. In a case where the file associated with the dropped file icon is present on the Internet outside the terminal apparatus 101, the CPU 103 starts to receive the file from the Internet and starts to store the file to the predetermined storage region. In addition, the CPU 103 may store, to the predetermined storage region, only a file in a data format supported by the printing application among the files associated with the file icons dropped, and may not store a file in a data format not supported by the printing application. In a case that a plurality of file icons are dropped on the application icon associated with the printing application, the CPU 103 starts to store, to the predetermined storage region, only a single file among the plurality of files associated with the plurality of file icons. The order in which the processing in S309 and the processing in S308 are executed is not limited. That is, for example, after the storing of the file associated with the file icon dropped on the application icon associated with the printing application is started, the processing of instructing the printing application to execute the second method may be executed and the file path may be acquired by the printing application. In addition, a file already stored in the predetermined storage region is present among the files associated with the file icons dropped on the application icon associated with the printing application, processing of storing the file to the predetermined storage region may be omitted. After S309, the process of the flowchart in FIG. 3 ends.

In the present embodiment, as described above, the method to be executed by the OS is switched based on whether an application associated with an application icon on which a file icon has been dropped supports the first method. In this form, in a case that a file icon is dropped on an application icon, the OS can execute processing suitable for characteristics of an application associated with the application icon. As described above, in a case that a plurality of file icons are dropped on the application icon associated with the printing application, the first method is superior to the second method in that the printing application can acquire a plurality of files associated with the plurality of file icons dropped. Therefore, it is possible to execute a more superior file sharing function by causing an application supporting the first method to execute a more superior method. Meanwhile, by causing an application not supporting the first method to execute the second method, it is possible to implement the file sharing function without crashing the application.

The file sharing function of the OS can be executed by an operation other than dropping of a file icon on the application icon associated with the printing application. Specifically, for example, in a case that any one of file icons displayed by the file management application is selected by the user, a screen on which an image indicated by a file associated with the selected file icon is displayed is displayed by the file management application. The screen includes a predetermined button displayed by the file management application. The predetermined button is a button for executing the file sharing function. When the predetermined button is operated by the user, the file management application executes an API for executing the file sharing function of the OS. When the API is executed, the OS executes the file sharing function described below. In this case, a file as a target for the file sharing function of the OS is the single file associated with the selected file icon. Specifically, for example, in a case that a file icon is long pressed in a state in which the user selects one or more of the file icons displayed by the file management application, the file management application displays a menu for designating processing to be executed on one or more files associated with the selected one or more file icons. The menu includes a predetermined button displayed by the file management application. The predetermined button is a button for executing the file sharing function. When the predetermined button is operated by the user, the file management application executes the API for executing the file sharing function of the OS. When the API is executed, the OS executes the file sharing function described below. In this case, the file as the target for the file sharing function of the OS is the one or more files associated with the selected one or more file icons. The file sharing function of the OS can be executed by a method other than the above-exemplified methods. An operation for executing the file sharing function of the OS may vary for each file management application.

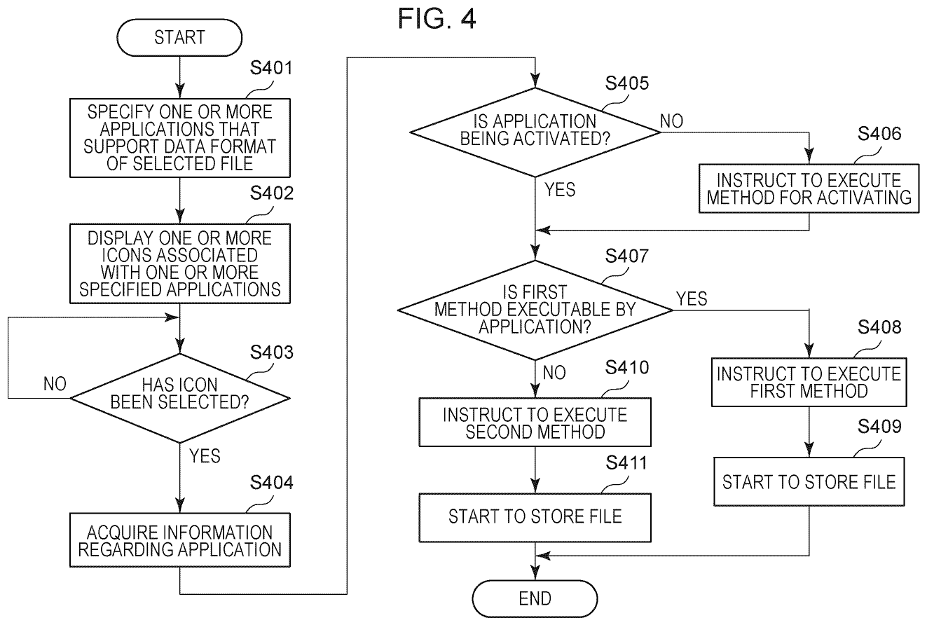

FIG. 4 is a flowchart illustrating a process that is executed by the terminal apparatus 101 using the OS. The flowchart in FIG. 4 is implemented by the CPU 103 reading the program (specifically, the OS) stored in the ROM 104 into the RAM 105 and executing the read program. It is assumed that the flowchart in FIG. 4 is started based on the above-described predetermined button, which is displayed by the file management application, being operated.

In S401, the CPU 103 specifies, among all applications installed in the terminal apparatus 101, one or more applications that support the file sharing function of the OS and a data format of the file as the target for the file sharing function of the OS. It is assumed that, in a case where a plurality of files are present as targets for the file sharing function, the CPU 103 specifies one or more applications that support a data format of the first file in the order of the plurality of files as the targets for the file sharing function of the OS.

In S402, the CPU 103 displays a region including one or more application icons associated with the specified one or more applications. The region may be displayed overlapping the screen displayed by the file management application.

In S403, the CPU 103 determines whether any one of the one or more application icons displayed has been selected by the user. In a case that the CPU 103 determines YES in S403, the process proceeds to S404. In a case that the CPU 103 determines NO in S403, this processing in S403 is repeated and the CPU 103 stands by until any one of the one or more application icons is selected by the user. The description will proceed on the assumption that an application associated with the application icon selected in S403 is the printing application.

In S404, the CPU 103 acquires the information regarding the printing application from the printing application. This processing in S404 is the same as or similar to the processing in S301.

In S405, the CPU 103 determines whether the printing application is being activated. The process of the flowchart in FIG. 4 is executed in a state in which the file management application is displayed. Therefore, a state in which the printing application is being activated at the time of making the determination in S405 corresponds to a state in which the printing application is being executed in a background process. In a case that the CPU 103 determines that the printing application is not being activated, the process proceeds to S406. In a case that the CPU 103 determines that the printing application is being activated, the process proceeds to S407.

In S406, the CPU 103 instructs the printing application to execute the method for activating the printing application. Therefore, the printing application is activated and the screen displayed on the display unit 108 is switched from the screen displayed by the file management application to the screen displayed by the printing application.

In S407, the CPU 103 determines, based on the method information acquired in S404, whether the first method is executable by the printing application. The determination as to whether the first method is executable by the printing application is, in other words, a determination as to whether the printing application supports the first method. In S407, specifically, the CPU 103 determines whether the printing application supports the UISceneDelegate protocol. In a case that the CPU 103 determines that the first method is executable by the printing application, the process proceeds to S408. In a case that the CPU 103 determines that the first method is not executable by the printing application, the process proceeds to S410.

In S408, the CPU 103 instructs the printing application to execute the first method. The processing in S408 is the same as or similar to the processing in S306. In the processing of instructing the printing application to execute the first method, in a case that a predetermined button is operated in a state in which a plurality of file icons are selected, the CPU 103 can cause the printing application to acquire a plurality of file paths associated with a plurality of files associated with the plurality of file icons selected. In a case that the predetermined button is operated in a state in which the plurality of file icons are selected, the printing application can acquire the plurality of files associated with the plurality of file icons selected.

In S409, the CPU 103 starts to store, to a predetermined storage region accessible by the printing application, a file as a target for the file sharing function of the OS. In a case where the file as the target for the file sharing function of the OS is present on the Internet outside the terminal apparatus 101, the CPU 103 starts to receive the file from the Internet and starts to store the file to the predetermined storage region. In addition, the CPU 103 may store, to the predetermined storage region, only a file in a data format supported by the printing application among files as targets for the file sharing function of the OS and may not store a file in a data format not supported by the printing application. In a case that a predetermined button is operated in a state in which a plurality of file icons are selected, the CPU 103 starts to store, to the predetermined storage region, a plurality of files that are targets for the file sharing function of the OS and are associated with the plurality of file icons. The order in which the processing in S408 and the processing in S409 are executed is not limited. That is, for example, after the storing of the file associated with the selected file icon is started, the processing of instructing the printing application to execute the first method may be executed and a file path may be acquired by the printing application. In a case where a file already stored in the predetermined storage region is present among the files as targets for the file sharing function of the OS, processing of storing the file to the predetermined storage region may be omitted. For example, the file already stored in the predetermined storage region was a file set as a target for the file sharing function of the OS by an operation of a predetermined button in the past. After S409, the process of the flowchart in FIG. 4 ends.

In S410, the CPU 103 instructs the printing application to execute the second method. The processing in S410 is the same as or similar to the processing in S308. In the processing of instructing the printing application to execute the second method, even in a case that a predetermined button is operated in a state in which a plurality of file icons are selected, the CPU 103 can cause the printing application to acquire only a single file path associated with a single file associated with a single file icon among the plurality of file icons selected. Even in a case that the predetermined button is operated in a state in which a plurality of file icons are selected, the printing application can cause the printing application to acquire only a single file associated with a single file icon among the plurality of file icons selected.

In S411, the CPU 103 starts to store, to a predetermined storage region accessible by the printing application, a file as a target for the file sharing function of the OS. In a case where the file as the target for the file sharing function of the OS is present on the Internet outside the terminal apparatus 101, the CPU 103 starts to receive the file from the Internet and starts to store the file to the predetermined storage region. The CPU 103 may store, to the predetermined storage region, only a file in a data format supported by the printing application among files as targets for the file sharing function of the OS and may not store a file in a data format not supported by the printing application. In a case that a predetermined button is operated in a state in which a plurality of file icons are selected, the CPU 103 starts to store, to the predetermined storage region, only a single file among a plurality of files associated with the plurality of file icons. The order in which the processing in S410 and the processing in S411 are executed is not limited. That is, for example, after the storing of the file associated with the selected file icon is started, the processing of instructing the printing application to execute the second method may be executed and a file path may be acquired by the printing application. In a case where a file already stored in the predetermined storage region is present among files as targets for the file sharing function of the OS, processing of storing the file to the predetermined storage region may be omitted. For example, the file already stored in the predetermined storage region was a file set as a target for the file sharing function of the OS by an operation of the predetermined button in the past. After S411, the process of the flowchart in FIG. 4 ends.

Next, processes that are executed by the printing application based on instructions from the OS to the printing application to execute the first method and the second method will be described.

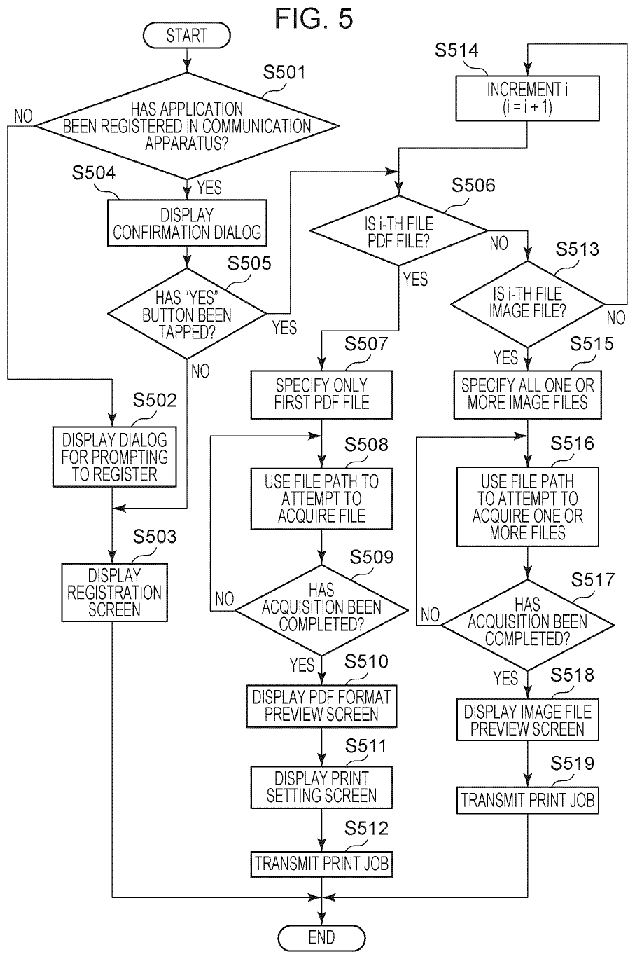

FIG. 5 is a flowchart illustrating a process that is executed by the terminal apparatus 101 using a printing application (hereinafter referred to as a first printing application) that supports the first method. The flowchart in FIG. 5 is implemented by the CPU 103 reading the program (specifically, the first printing application) stored in the ROM 104 into the RAM 105 and executing the read program. It is assumed that the flowchart in FIG. 5 is started based on a file icon being dragged and dropped on the application icon associated with the first printing application. In addition, it is assumed that the flowchart in FIG. 5 is started based on the application icon, which is associated with the first printing application, being selected from among one or more application icons displayed by the OS when a predetermined button is operated. More specifically, it is assumed that the flowchart is in FIG. 5 is started based on an instruction from the OS to the first printing application to execute the first method. In the following description of the flowchart in FIG. 5, the printing application is the first printing application.

In S501, the CPU 103 determines whether the communication apparatus 151 has been registered in the printing application. In the present embodiment, the communication apparatus 151 can be registered in the printing application by the printing application acquiring ability information of the communication apparatus 151 from the communication apparatus 151 connected to the terminal apparatus 101 via the network.

That is, a state in which the communication apparatus 151 is not registered in the printing application corresponds to a state in which the printing application has not registered the ability information of the communication apparatus 151 from the communication apparatus 151 connected to the terminal apparatus 101 via the network. In a case where the communication apparatus 151 is registered in the printing application, the printing application can transmit a print job and a scan job to the communication apparatus 151. In a case that the CPU 103 determines NO in S501, the process proceeds to S502. In a case that the CPU 103 determines YES in S501, the process proceeds to S504.

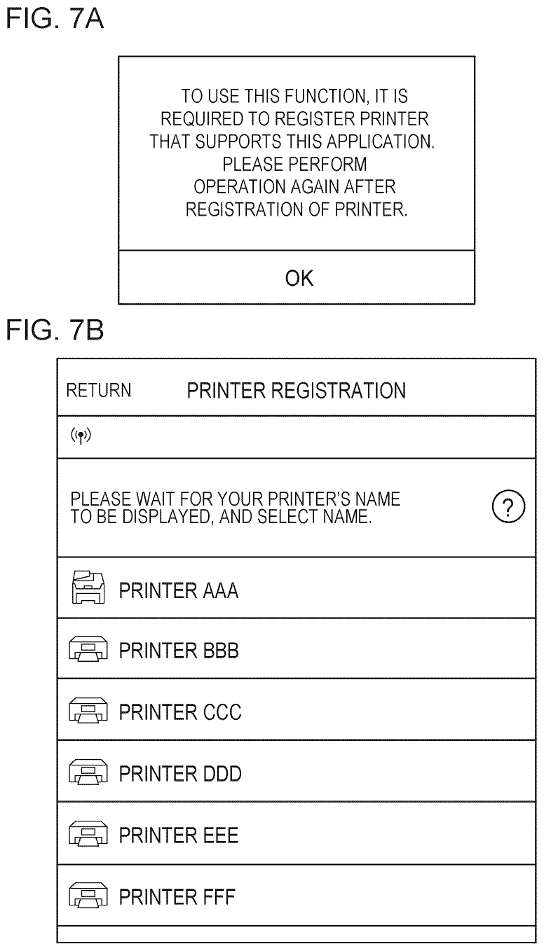

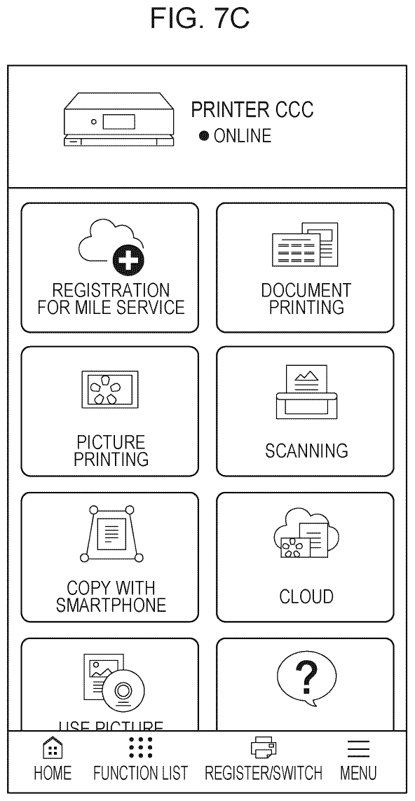

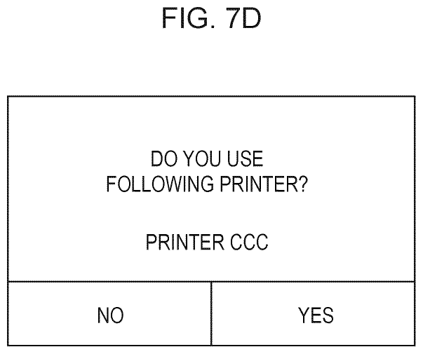

In S502, the CPU 103 displays a dialog including a message for prompting the user to register the communication apparatus 151 in the printing application. FIG. 7A illustrates an example of the dialog displayed in this case. The dialog includes an OK button. In a case that the OK button is tapped, the process proceeds to S503.

In S503, the CPU 103 displays a registration screen for registering the communication apparatus 151 in the printing application. FIG. 7A illustrates an example of the registration screen displayed in this case. In the processing in S503, the CPU 103 searches for one or more communication apparatuses 151 that are present on the network to which the terminal apparatus 101 is connected, and support the printing application. Then, a list of the communication apparatuses 151 found in this search is displayed on the registration screen. The one or more communication apparatuses 151 that support the printing application are provided by the same vendor as that of the printing application. When any one of the one or more communication apparatuses 151 is selected from the list, the CPU 103 starts to communicate with the selected communication apparatus 151 and acquires ability information of the selected communication apparatus 151. Therefore, the selected communication apparatus 151 is registered in the printing application. When the registration is completed, a home screen for the printing application is displayed as illustrated in FIG. 7C, and the process of the flowchart in FIG. 5 ends. On the home screen for the printing application, an icon indicating the communication apparatus 151 registered in the printing application is displayed. In addition, on the home screen for the printing application, buttons for executing various functions executable by the printing application are displayed. After the registration is completed, the process may proceed to S506 without displaying the home screen for the printing application in order to print a file dropped on the application icon associated with the printing application.

In S504 executed in a case that the result of the determination in S501 is YES, the CPU 103 displays a confirmation dialog for confirming with the user whether to perform printing using the communication apparatus 151 currently registered in the printing application. FIG. 7D illustrates an example of the dialog displayed in this case. In the confirmation dialog, the name or model number of the communication apparatus 151 currently registered in the printing application is displayed. In addition, the confirmation dialog includes a “Yes” button and a “No” button. When any one of the “Yes” button and the “No” button is tapped, the process proceeds to S505.

In S505, the CPU 103 determines whether the “Yes” button has been tapped. In a case that the CPU 103 determines No in S505 based on the “No” button tapped, the process proceeds to S503 and the CPU 103 executes processing of registering another communication apparatus 151 in the printing application. On the other hand, in a case that the CPU 103 determines YES in S505 based on the “Yes” button tapped, the process proceeds to S506.

In S506, the CPU 103 determines whether the i-th file in the order of files as targets for the file sharing function of the OS is a PDF format file. The files as the targets for the file sharing function of the OS include a file associated with a file icon dropped on the application icon associated with the printing application and a file associated with a file icon selected when a predetermined button is operated. The order of the files is the order in which the files are input from the OS to the printing application by the first method or the second method. In addition, the order of the files may be the order of the files sorted in the list screen displayed by the file management application. That is, for example, in a case where names of the files are sorted in the list screen, the order of the files may be the order of the names. In a case where data sizes of the files are sorted in the list screen, the order of the files may be the order of the data sizes. An initial value of i is 1. In a case that the CPU 103 determines YES in S506, the process proceeds to S507. In a case that the CPU 103 determines NO in S506, the process proceeds to S513. The case where the CPU 103 determines NO in S506 is specifically a case where the i-th file in the order of the files is any one of a JPEG format file, a HEIF format file, and a PNG format file. The JPEG format file, the HEIF format file, and the PNG format file are image files. Each of the image files includes only an image for a single page, while a single PDF format file may include images for a plurality of pages.

In S507, the CPU 103 specifies only the first file in the order of PDF format files as targets for the file sharing function of the OS. Only the file specified in S507 among the files as the targets for the file sharing function of the OS is displayed on a preview screen. Specifically, for example, in a case where only a single PDF format file is a file as a target for the file sharing function of the OS, only the single file is specified. In addition, for example, in a case where a plurality of PDF format files are files as targets for the file sharing function of the OS, the first file in the order of the plurality of PDF format files is specified. Further, for example, in a case where files dropped on the application icon associated with the printing application include a file in a format not matching the format indicated by the format information and PDF format files, and the file in the format not matching the format indicated by the format information is input to the printing application earlier than the PDF format files in the order of the files, the file in the format not matching the format indicated by the format information is not specified, and the first file in the order of the PDF format files is specified.

In S508, the CPU 103 uses a file path received from the OS to attempt to acquire the file that has been held in a region indicated by the received file path and has been specified in S507. As described above, the region indicated by the file path is within the above-described predetermined storage region.

In S509, the CPU 103 determines whether the acquisition of the file specified in S507 by the attempt in S508 has been completed. In a case that the CPU 103 determines YES in S509, the process proceeds to S510. In a case that the CPU 103 determines NO in S509, the process returns to S508. For example, in a case where a file as a target for the file sharing function of the OS is present on the Internet outside the terminal apparatus 101, the terminal apparatus 101 needs to acquire the file from the Internet and it takes time to complete the storing of the file. That is, at the time of the attempt made in S508 (that is, at the start time of the attempt in S508), the storing of the file to the predetermined storage region by the OS may not be completed. Therefore, in the present embodiment, in a case where a file as a target for the file sharing function of the OS is present on the Internet outside the terminal apparatus 101, the determination processing in S509 and the processing due to the determination processing in S509 are repeatedly performed to repeatedly attempt to acquire the file until the acquisition of the file from the Internet and the storing of the file to the predetermined storage region are completed.

In a case where the data size of a file associated with a dropped file icon is large or the performance of the CPU 103 is low, it may take time to complete the storing of the file. In such a case, the repetition of the determination processing and the processing due to the determination processing is effective. The CPU 103 may stand by for a predetermined time period until an attempt to acquire the file is made again.

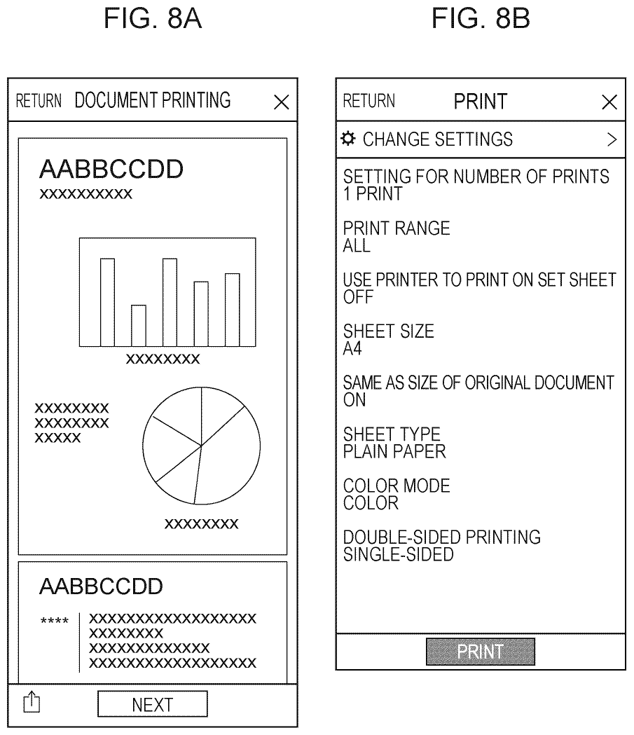

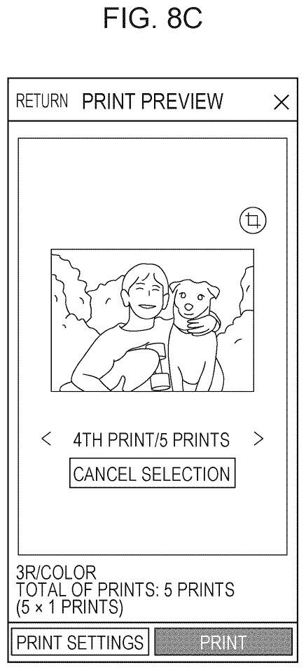

In S510, the CPU 103 uses the file acquired by the attempt in S508 to display a PDF format preview screen for previewing an image indicated by the file. FIG. 8A illustrates an example of the PDF format preview screen displayed in this case. In a case where the acquired file includes data for a plurality of pages, images for the plurality of pages can be displayed on the PDF format preview screen, and the image displayed on the PDF format preview screen is switched by performing a scroll operation on the PDF format preview screen. The PDF format preview screen includes a “next” button. When the “next” button is tapped, the process proceeds to S511.

In S511, the CPU 103 displays a print setting screen for entering a print setting to be used for printing the image previewed in S510. FIG. 8B illustrates an example of the print setting screen displayed in this case. The contents of print settings currently set are displayed on the print setting screen. The print setting screen includes a “change settings” button. When the “change settings” button is tapped, a change screen for changing the contents of the print settings is displayed. When the contents of the print settings are changed on the change screen, the contents displayed on the print setting screen are also changed. The print setting screen further includes a “print” button. When the “print” button is tapped, the process proceeds to S512.

In S512, the CPU 103 generates print data for printing, based on the print settings set in S511, the image indicated by the file acquired by the attempt in S508. Then, the CPU 103 transmits a print job including the print data to the communication apparatus 151 registered in the printing application. The communication apparatus 151 that has received the print job performs printing based on the print job to print the image indicated by the file acquired by the attempt in S508. After S512, the process of the flowchart in FIG. 5 ends.

In S513 executed in a case that the result of the determination in S506 is NO, the CPU 103 determines whether the i-th file in the order of the files as the targets for the file sharing function of the OS is an image file. As described above, an image file is a file in a format matching the format indicated by the format information and is any one of a JPEG format file, a HEIF format file, and a PNG format file. In a case that the CPU 103 determines YES in S513, the process proceeds to S515. In a case that the CPU 103 determines NO in S513, the process proceeds to S514. The case where the CPU 103 determines NO in S513 is specifically a case where the i-th file in the order of the files is not any of a PDF format file, a JPEG format file, a HEIF format file, and a PNG format file. In other words, the case where the CPU 103 determines NO in S513 is a case where the i-th file in the order of the files is in a format not matching the format indicated by the format information.

In S514, the CPU 103 increments the value of i by 1. That is, the CPU 103 sets, as a new value of i, a value obtained by adding 1 to the current value of i. Then, the CPU 103 causes the process to return to the processing in S506. Therefore, in the processing in S506 and the subsequent processing, a file of the incremented value in the order of the files is referenced.

In S515, the CPU 103 specifies all one or more image files among the files as the targets for the file sharing function of the OS. The CPU 103 displays, on the preview screen, the one or more files specified in S515 among the files as the targets for the file sharing function of the OS. Specifically, for example, in a case where only a single image file is a file as a target for the file sharing function of the OS, only the single file is specified. In addition, for example, in a case where a plurality of image files are files as targets for the file sharing function of the OS, all the image files are specified. Further, for example, in a case where files as targets for the file sharing function of the OS include a file in a format not matching the format indicated by the file information and image files, and the file in the format not matching the format indicated by the format information is input to the printing application earlier than the image files in the order of the files, the file in the format not matching the format indicated by the format information is not specified and all the image files are specified.

In S516, the CPU 103 uses the file path received from the OS to attempt to acquire the one or more files that are stored in the region indicated by the file path and have been specified in S515.

In S517, the CPU 103 determines whether the acquisition of the one or more files specified in S515 has been completed by the attempt in S516. In a case that the CPU 103 determines YES in S517, the process proceeds to S518. In a case that the CPU 103 determines NO in S517, the process returns to S516. As described above, in a case where a file as a target for the file sharing function of the OS is present on the Internet outside the terminal apparatus 101, the attempt to acquire the file is repeated until the acquisition of the file from the Internet and the storing of the file are completed.

In S518, the CPU 103 uses the one or more files acquired by the attempt in S516 to display an image file preview screen for previewing one or more images indicated by the one or more files. FIG. 8C illustrates an example of the image file preview screen displayed in this case. The image file preview screen includes a preview region for displaying an image indicated by an acquired image file. In a case where a plurality of image files acquired are present, an image displayed in the preview region is switched from an image indicated by a first image file among the plurality of image files to an image indicated by a second image file among the plurality of image files by performing a scroll operation on the image file preview screen. On the image file preview screen, a print setting screen for entering a print setting to be used for printing the one or more files acquired by the attempt in S516 is displayed. On the print setting screen, the contents of print settings currently set are displayed. The print setting screen includes a “change settings” button. When the “change settings” button is tapped, a change screen for changing the contents of print settings is displayed. When the contents of the print settings are changed on the change screen, the contents displayed on the print setting screen are also changed. The image file preview screen includes a “print” button. When the “print” button is tapped, the process proceeds to S519.

In S519, the CPU 103 generates print data for printing, based on the print settings set in S518, the one or more images indicated by the one or more files acquired by the attempt in S516. The CPU 103 transmits a print job including the print data to the communication apparatus 151 registered in the printing application. In a case that a plurality of files are acquired by the attempt in S516, the CPU 103 transmits a print job including print data for printing a plurality of images indicated by the plurality of files to the communication apparatus 151 registered in the printing application. The communication apparatus 151 that has received the print job performs printing based on the print job to print the one or more images indicated by the one or more files acquired by the attempt in S516. After S519, the process of the flowchart in FIG. 5 ends.

In the present embodiment, as described above, processing that is executed in a case that a predetermined method is executed by the OS is programmed in the printing application, and thus the printing application can process a file associated with a dropped file icon.

In the present embodiment, it is possible to execute processing appropriate for a file format of a file associated with a dropped file icon. As described above, a single PDF format file may include images for a plurality of pages. Therefore, in a case that a plurality of file icons associated with a plurality of PDF format files are dropped on the application icon associated with the printing application, and a preview screen for printing the plurality of PDF format files is displayed, many pages need to be displayed for preview and a processing load of the printing application may be high. Meanwhile, a single image file includes only an image for a single page. Therefore, in a case that a plurality of file icons associated with a plurality of image files are dropped on the application icon associated with the printing application, and a preview screen for printing the plurality of image files is displayed, the processing load of the printing application is unlikely to be high. In the present embodiment, in a case that a plurality of file icons associated with a plurality of files are dropped, only a single PDF format file is specified and displayed for preview, a plurality of image files are specified and displayed for preview, and control can be performed to print many images at once while the processing load of the printing application is controlled such that the processing load of the printing application is not high.

In the present embodiment, even in a case that a plurality of file icons associated with a plurality of files are dropped, and the plurality of files include both a file not supported by the printing application and a file supported by the printing application, processing based on the files, such as displaying for preview and transmission of a print job, is not canceled. In the present embodiment, in this case, only the file supported by the printing application can be extracted and processing based on the file can be performed, and thus the user convenience is improved.

In the present embodiment, in a situation in which a file associated with a dropped file icon is present on the Internet and it takes time to acquire and store the file by the OS, processing based on the file is not canceled. In the present embodiment, in this case, the printing application can execute the processing based on the file after the acquisition and storing of the file are completed by the OS, and thus the user convenience is improved.

In the present embodiment, in a case that a file icon is dropped on the application icon associated with the printing application in a state in which a printer is not registered in the printing application, processing for registering the printer in the printing application is executed. Therefore, it is possible to suppress the occurrence of a situation in which a print job cannot be transmitted due to the fact that the printer is not registered in the printing application.

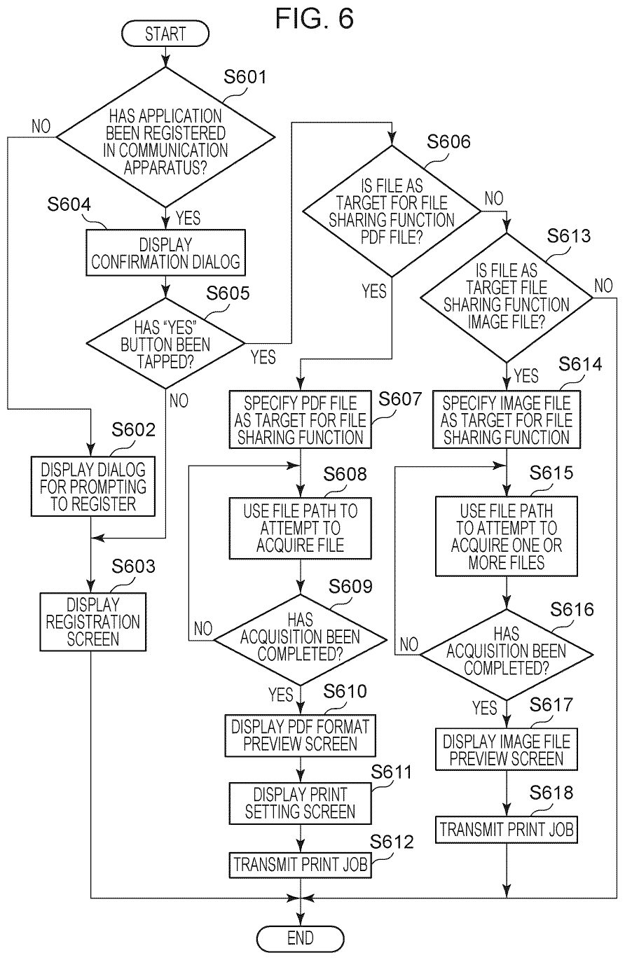

FIG. 6 is a flowchart illustrating a process that is executed by the terminal apparatus 101 using a printing application (hereinafter referred to as a second printing application) that does not support the first method and supports the second method. The flowchart in FIG. 6 is implemented by the CPU 103 reading the program (specifically, the second printing application) stored in the ROM 104 into the RAM 105 and executing the read program. It is assumed that the flowchart in FIG. 6 is started based on a file icon being dragged and dropped on an application icon associated with the second printing application.

In addition, it is assumed that the flowchart in FIG. 6 is started based on the application icon, which is associated with the second printing application, being selected from among one or more application icons displayed by the OS when a predetermined button is operated. More specifically, it is assumed that the flowchart in FIG. 6 is started based on an instruction from the OS to the second printing application to execute the second method. A vendor that provides the second printing application may be different from the vendor that provides the first printing application. In the following description about the flowchart in FIG. 6, a printing application is the second printing application.

Processing in S601 to S605 is the same as or similar to the processing in S501 to S505.

In S606, the CPU 103 determines whether a file as a target for the file sharing function of the OS is a PDF format file. As described above, in the second method, only a single file is shared and thus only a single file is referenced in S606.

In a case that the CPU 103 determines YES in S606, the process proceeds to S607. In a case that the CPU 103 determines NO in S606, the process proceeds to S613.

In S607, the CPU 103 specifies the PDF format file as a target for the file sharing function of the OS. The file specified in S607 is displayed on the preview screen.

Processing in S608 to S612 is the same as or similar to the processing in S508 to S512.

In S613 executed in a case that the result of the determination in S606 is NO, the CPU 103 determines whether the file as the target for the file sharing function of the OS is an image file. As described above, in the second method, only a single file is shared and thus only a single file is referenced in S613. In a case that the CPU 103 determines YES in S613, the process proceeds to S614. In a case that the CPU 103 determines NO in S613, the process of the flowchart in FIG. 6 ends. In a case that the CPU 103 determines NO in S613, the CPU 103 may display an error screen and display a home screen for the printing application without displaying the preview screen.

In S614, the CPU 103 specifies the image file as a target for the file sharing function of the OS. The file specified in S614 is displayed on the preview screen.

Processing in S615 to S618 is the same as or similar to the processing in S515 to S518.

The form in which the processing executed by the first printing application based on the instruction to execute the first method is different from the processing executed by the second printing application in a case that the instruction to execute the second method is provided is described above. The present embodiment is not limited thereto. The contents of the processing executed by the first printing application based on the instruction to execute the first method may be the same as the contents of the processing executed by the second printing application in a case that the instruction to execute the second method is provided.

As described above, the first method supports sharing of a plurality of files. In this form, for example, in both a case that an instruction to execute the first method is provided and a case that an instruction to execute the second method is provided, only a single file is shared. Whether to accept sharing of a plurality of files may be controlled on an application side on which the first method is executed, and this form may be implemented.

The form in which the printing applications execute the processing based on the instruction to execute the first method and the instruction to execute the second method is described above. However, the present embodiment is not limited thereto. An application that executes the processing based on the instruction to execute the first method may be any one of applications that handle a file, such as an application for editing a document file, an application for editing an image file, the file management application, a camera application, and an application for creating an album. In a case where an application other than the printing applications executes the processing based on the instruction to execute the first method and the instruction to execute the second method, a process different from the process described with reference to FIG. 5 is executed.

### Other Embodiments

In the form described above, in the process of the flowchart in FIG. 5, specifying only a single file and specifying a plurality of files are switched based on whether a file associated with a file icon dropped on the application icon associated with the printing application is a PDF format file or an image file. However, the process is not limited thereto. Only a single file may be specified regardless of whether the file is a PDF format file or an image file. That is, in the processing in S515, only the first file in the order of a plurality of files that are image files and are associated with file icons dropped on the application icon associated with the printing application may be specified. In addition, only a plurality of files may be specified regardless of whether a file associated with a file icon dropped on the application icon associated with the printing application is a PDF format file or an image file. That is, in the processing in S507, all PDF format files may be specified among a plurality of files associated with file icons dropped on the application icon associated with the printing application.

In the form described above, in the process of the flowchart in FIG. 5, in a case where the i-th file is neither a PDF format file nor an image file, i is incremented and a file format is determined for a file of the next number. However, the process is not limited thereto. In a case where the first file in the order of the files is neither a PDF format file nor an image file, an error display or the home screen for the printing application may be displayed without the preview screen being displayed. That is, in a case that the CPU 103 determines NO in S513, the process may proceed to processing of displaying the error screen without proceeding to the processing in S514.

The object of various embodiments of the present disclosure can be achieved by supplying a storage medium (storing a program code of software) for implementing the example functions described above to a system or an apparatus and a computer (or CPU or MPU, for example) of the system or the apparatus reading and executing the program code stored in the storage medium. In such cases, the program code read from the storage medium, when executed, implements the functions described above, and the storage medium storing the program code is included within the scope of the present disclosure.

As the storage medium for storing the program code, for example, a flexible disk, a hard disk, an optical disc, a magneto-optical disc, a CD-ROM, a CD-R, a magnetic tape, a nonvolatile memory card, a ROM, a DVD, and the like can be used.

The computer reads and executes the program code to not only implement the functions described in the above description of embodiments but also performs some or all of the processes executed by the operating system (OS) or the like on the computer so as to implement the functions described above by the processes.

According to various embodiments of the present embodiment, it is possible to improve the convenience of the form in which the information processing apparatus receives an operation of dragging and dropping a file icon.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-146301, which was filed on Sep. 8, 2023 and which is hereby incorporated by reference herein in its entirety.

What is claimed is:

1. A method for controlling an information processing apparatus having a predetermined program, the method comprising:
executing, based on receiving a dragging operation of dragging a file icon included in a screen displayed by a first application program and a dropping operation of dropping the dragged file icon on an application icon associated with a second application program and based on a fact that the second application program supports a first method, first processing for sharing a file associated with the dropped file icon with the second application program by the first method; and
executing, based on receiving a dragging operation of dragging the file icon included in the screen displayed by the first application program and a dropping operation of dropping the dragged file icon on an application icon associated with a third application program and based on a fact that the third application program does not support the first method, second processing for sharing the file associated with the dropped file icon with the third application program by a second method.

2. The control method according to claim 1, wherein the predetermined program is an operating system of the information processing apparatus.

3. The control method according to claim 1, wherein in the first method, in a case that an operation of dropping, on the application icon associated with the second application program, a plurality of file icons included in the screen displayed by the first application program is received, a plurality of files associated with the plurality of file icons dropped are enabled to be shared with the second application program.

4. The control method according to claim 1, wherein in the second method, in a case that an operation of dropping, on the application icon associated with the second application program, a plurality of file icons included in the screen displayed by the first application program is received, only any one of a plurality of files associated with the plurality of file icons dropped is enabled to be shared with the second application program.

5. The control method according to claim 1, wherein
the first processing includes processing of storing the file associated with the dropped file icon to a storage region accessible by the second application program, and
the second processing includes processing of storing the file associated with the dropped file icon to a storage region accessible by the third application program.

6. The control method according to claim 1, wherein
in a case where the file associated with the dropped file icon is present on the Internet, the first processing and the second processing include processing of receiving the file associated with the dropped file icon from the Internet.

7. The control method according to claim 1, wherein
the first processing includes processing of causing the second application program to acquire a file path indicating a region in which the file associated with the dropped file icon is stored, and identification information of the first application program that displayed the dropped file icon, and
the second processing includes processing of causing the third application program to acquire the file path indicating the region in which the file associated with the dropped file icon is stored, and the identification information of the first application program that displayed the dropped file icon.

8. The control method according to claim 1, wherein
the first processing includes processing of activating the second application program, and
the second processing includes processing of activating the third application program.

9. The control method according to claim 1, further comprising:
displaying a plurality of application icons including the application icon associated with the second application program and the application icon associated with the third application program based on a predetermined operation being performed on the screen displayed by the first application program after the file icon included in the screen displayed by the first application program is selected, the predetermined operation being different from the dragging operation and the dropping operation;
executing, based on a fact that the second application program is selected from among the plurality of application icons displayed and the second application program supports the first method, processing for sharing the file associated with the selected file icon with the second application program by the first method; and
executing, based on a fact that the third application program is selected from among the plurality of application icons displayed and the third application program does not support the first method, processing for sharing the file associated with the selected file icon with the third application program by the second method.

10. The control method according to claim 9, further comprising
specifying, based on the predetermined operation being performed on the screen displayed by the first application program, a plurality of application programs supporting a data format of the file associated with the selected file icon among all application programs installed in the information processing apparatus after the file icon included in the screen displayed by the first application program is selected, wherein
the plurality of application icons associated with the plurality of application programs specified are displayed based on the predetermined operation being performed on the screen displayed by the first application program after the file icon included in the screen displayed by the first application program is selected.

11. The control method according to claim 10, wherein
in a case that the predetermined operation is performed on the screen displayed by the first application program after a plurality of file icons included in the screen displayed by the first application program are selected, the plurality of application programs supporting a data format of a file associated with a first icon among the plurality of file icons selected are specified among all the application programs installed in the information processing apparatus.

12. The control method according to claim 1, wherein
the first method is scene(_:openURLContexts:) defined in a UISceneDelegate protocol.

13. The control method according to claim 1, wherein
the first method is scene(_:willConnectTo:options:) defined in a UISceneDelegate protocol.

14. The control method according to claim 1, wherein
in a case where the second application program associated with the application icon on which the file icon has been dropped is activated, the first method is scene(_openURLContexts:) defined in a UISceneDelegate protocol, and
in a case where the second application program associated with the application icon on which the file icon has been dropped is not activated, the first method is scene(_:willConnectTo:options:) defined in the UISceneDelegate protocol.

15. The control method according to claim 1, wherein
the second method is application(_:open:options:) defined in a UIApplicationDelegate protocol.

16. The control method according to claim 1, wherein
the second application program and the third application program are printing application programs.

17. The control method according to claim 1, wherein
in a case that the first processing is executed, processing of displaying an image based on the file associated with the dropped file icon is executed by the second application program, and
in a case that the second processing is executed, the processing of displaying the image based on the file associated with the dropped file icon is executed by the third application program.

18. The control method according to claim 1, wherein
the predetermined program is at least one of iOS 17, iPadOS 17, and iOS of a version later than iOS 17.

19. An information processing apparatus comprising:
at least one memory storing instructions; and
at least one processor that is in communication with the at least one memory and that, when executing the instructions, cooperates with the at least one memory to:
execute, based on receiving a dragging operation of dragging a file icon included in a screen displayed by a first application program and a dropping operation of dropping the dragged file icon on an application icon associated with a second application program and based on a fact that the second application program supports a first method, first processing for sharing a file associated with the dropped file icon with the second application program by the first method; and
execute, based on receiving a dragging operation of dragging the file icon included in the screen displayed by the first application program and a dropping operation of dropping the dragged file icon on an application icon associated with a third application program and based on a fact that the third application program does not support the first method, second processing for sharing the file associated with the dropped file icon with the third application program by a second method.

20. A non-transitory computer-readable storage medium storing computer-executable instructions that, when executed by a computer of an information processing apparatus, cause the information processing apparatus to execute:
based on receiving a dragging operation of dragging a file icon included in a screen displayed by a first application program and a dropping operation of dropping the dragged file icon on an application icon associated with a second application program and based on a fact that the second application program supports a first method, first processing for sharing a file associated with the dropped file icon with the second application program by the first method; and
based on receiving a dragging operation of dragging the file icon included in the screen displayed by the first application program and a dropping operation of dropping the dragged file icon on an application icon associated with a third application program and based on a fact that the third application program does not support the first method, second processing for sharing the file associated with the dropped file icon with the third application program by a second method.
